(19) United States
(12) Patent Application Publication
(10) Pub. No.: US 2025/0337993 A1
(43) Pub. Date: Oct. 30, 2025

(54) METHOD AND SYSTEM FOR ENHANCED MULTI-DIMENSIONAL SEARCHING OF VIDEO CONTENT

(71) Applicants: CHRISTOPHER BAILEY, OJAI, CA (US); CHARLES LEE HAMILTON, FORT BRAGG, CA (US)

(72) Inventors: CHRISTOPHER BAILEY, OJAI, CA (US); CHARLES LEE HAMILTON, FORT BRAGG, CA (US)

(21) Appl. No.: 19/262,816

(22) Filed: Jul. 8, 2025

Related U.S. Application Data
(63) Continuation-in-part of application No. 17/945,746, filed on Sep. 15, 2022, now Pat. No. 12,356,047.

(51) Int. Cl. H04N 21/482; H04N 21/472

(52) U.S. Cl. CPC H04N 21/4821; H04N 21/47202; H04N 21/4828

(57) ABSTRACT

In a method and system for performing a multi-dimensional search of video content, a displayed three-dimensional interactive grid may include a plurality of cells populated with video content in the form of named chapters and subchapters associated with each chapter, forming headers of the cells in a two-dimensional multiple column by multiple row arrangement. The cells may include containers of video content associated with each subchapter, representing the third dimension of the grid, with each container including one or more nodes of video snippets. A multi-dimensional search of the video content may be enabled to select a node and/or container. Selection may initiate a hierarchical search to display at least one or more new containers related to the selected node or container that are accessible in the presently displayed three dimensional interactive grid or in one or more different grids related to the video content of the selected node.

### CROSS REFERENCE TO RELATED APPLICATIONS

The present application claims priority under 35 U.S.C 120 to, and is a continuation-in-part of, co-pending and commonly-assigned U.S. patent application Ser. No. 17/945,746, filed Sep. 15, 2022, the entire contents of which is hereby incorporated by reference herein.

### TECHNICAL FIELD

The example embodiments in general are directed to a method and system for enhanced navigation of a three-dimensional interactive multi-dimensional search of video content.

### BACKGROUND

This section of this document introduces information about and/or from the art that may provide context for or be related to the subject matter described herein and/or claimed below. It provides background information to facilitate a better understanding of the various aspects of the present invention. This is a discussion of “related” art. That such art is related in no way implies that it is also “prior” art. The related art may or may not be prior art. The discussion in this section of this document is to be read in this light, and not as admissions of prior art.

Applicant has been involved in developing intra-program navigation technologies for video content for over fifteen (15) years. Applicant's initial patent, U.S. Pat. No. 7,669,128, entitled “METHODS OF ENHANCING MEDIA CONTENT NARRATIVE”, (the “128 patent”) was directed to a system and method which formatted content, such as for intra-program navigation, in a completely different way-a displayed row-by-column, two-dimensional (2D) navigation grid matrix that has a formatted organization between chapters (forming columns) and sub-chapters (forming rows and related to or tied to the columns). The chapter/sub-chapter organization of the navigation grid described in the '128 patent facilitated a user's ability to select their own navigation path through many selectable alternative scenes (that are not fixed or tied to a particular decision). The user selections would be stored in a desired sequence as a digital file, to be played back as a modified version of the video program being viewed.

Applicant built on this initial technology by developing the back end of the system, embodied in its second patent, U.S. Pat. No. 9,177,603, entitled “METHOD OF ASSEMBLING AN ENHANCED MEDIA CONTENT NARRATIVE”, (the “603 patent”). Namely, the '603 patent dealt with how to assemble or build out the 2D grid matrix for a video program with selectable video clips accessible by a viewer, in which the viewer builds an interactive navigation grid matrix for display. The method and system described in the '603 patent provided a fillable cell via an interface to enable the viewer to insert a title of the video program. The method and system also provided a plurality of fillable cells to enable the viewer to insert chapter and sub-chapter names for media content of the video program and a corresponding number of chapters and a number of sub-chapters, with the chapter and sub-chapter names forming headers of empty cells for a multiple row by multiple column interactive 2D navigation grid matrix displayable to the viewer. Using the interface, the viewer would be able to populate the empty cells of the 2D grid matrix with video clip file names, and then associate a selectable video clip in each sub-chapter with each selectable video clip file name. Thus, each video clip selectable by the viewer represented one of many alternative video program scenes of the video program.

Applicant further built on the technology in it previous two patents by developing a three dimensional interactive navigation grid matrix (“3D grid”) for display, as described in the pending. To enable the 3D grid, a plurality of containers of video content associated with each subchapter were added to represent the third dimension. Each of the containers were configured so as to be accessible within a corresponding subchapter of a given chapter. Each container included a plurality of nodes of video snippets associated therewith, the 3D grid displayed by the user interface such for a multi-dimensional search of the video content by the viewer.

### SUMMARY

An example embodiment of the present invention is directed to a method executed by one or more computing devices for enhanced navigation of a three-dimensional interactive grid for a multi-dimensional search of video content therein. In the method, at least one three-dimensional interactive grid may be displayed via a user interface. The grid may be composed of a plurality of cells populated with the video content or otherwise adapted to receive the video content therein. The plurality of cells may include a plurality of differently named chapters of the video content, and a plurality of differently named subchapters associated with each chapter, the plurality of chapters and subchapters forming headers of the plurality of cells in a multiple column by multiple row arrangement as two dimensions of the three dimensional interactive navigation grid. The plurality of cells may further include a plurality of containers of video content associated with each subchapter and representing a third dimension. Each container may be configured to contain one or more nodes of video snippets associated therewith. A multi-dimensional search may be enabled via the user interface of video content associated with selection of a given node in a given container or selection of a given container. The selection may initiate a hierarchical search to display at least one or more new containers related to the selected given node or given container. The new containers may be accessible in the presently displayed three dimensional interactive grid or accessible in one or more different three dimensional interactive grids related to the video content of the selected node.

Another example embodiment is directed to a three-dimensional interactive grid for a multi-dimensional search of video content therein that is displayable via a user interface. The three-dimensional interactive grid may include a plurality of cells. The plurality of cells may include a plurality of differently named chapters of the video content, the video content represented as pre-rendered, non-live program video content, and a plurality of differently named subchapters associated with each chapter, the plurality of chapters and subchapters forming two dimensions of the three dimensional interactive navigation grid, The grid may further include a plurality of containers associated with each subchapter and representing a third dimension, each container containing one or more nodes of video snippets of the pre-rendered, non-live program video content associated therewith, wherein the pre-rendered, non-live program video content is configured to be processed in real time.

Another example embodiment is directed to computer system adapted for enhanced navigation of a three-dimensional interactive grid for a multi-dimensional search of video content therein. The system includes a processing hardware set, and a computer-readable storage device medium. The processing hardware set may be structured, connected and/or programmed to run program instructions stored on the computer-readable storage medium instructions and associated data. The program instructions may include a display module programmed via a user interface to display at least one three-dimensional interactive grid composed of a plurality of cells populated with the video content or otherwise adapted to receive the video content therein. The plurality of cells may include a plurality of differently named chapters of the video content, a plurality of differently named subchapters associated with each chapter, the plurality of chapters and subchapters forming headers of the plurality of cells in a multiple column by multiple row arrangement as two dimensions of the three dimensional interactive navigation grid, and a plurality of containers of video content associated with each subchapter and representing a third dimension, each container containing one or more nodes of video snippets associated therewith. The program instructions may include a processing module programmed to enable a multi-dimensional search via the user interface of video content associated with selection of a given node in a given container, or selection of a given container, and to automatically initiate a hierarchical search to display at least one or more new containers related to the selected given node or given container. The new containers may be accessible in the presently displayed three dimensional interactive grid or accessible in one or more different three dimensional interactive grids related to the video content of the selected node.

### BRIEF DESCRIPTION OF THE DRAWINGS

The foregoing summary, as well as the following detailed description of illustrative embodiments, is better understood when read in conjunction with the appended drawings. Other aspects, features, and advantages of described embodiments will become more fully apparent from the following detailed description, the appended claims, and the accompanying drawings in which like reference numerals identify similar or identical elements. For the purpose of illustrating the embodiments, there is shown in the drawings example constructions of the embodiments; however, the embodiments are not limited to the specific methods and instrumentalities disclosed. In the drawings:

FIG. 1 is a block diagram representation of a three-dimensional interactive navigation grid matrix of video content according to the example embodiments.

FIG. 2 is a flow diagram to describe a method of performing a multi-dimensional search of video content accessible by a viewer thereof for the interactive navigation grid matrix of FIG. 1.

FIG. 3 is a block diagram to describe a system adapted to execute the multi-dimensional search method of FIG. 2.

FIG. 4 is block diagram to describe how video content from node sources is aggregated for digital transmission via a communication interface to the online media platform embodied by the system of FIG. 3.

FIG. 5 is a screenshot of an aggregator's collection of node sources, where the aggregator is embodied as a search engine.

FIG. 6 is a screenshot of an excel file which shows a functional representation of the grid matrix of FIG. 1 in terms of its constituent components.

FIG. 7 is a screenshot of a video to illustrate the 3-dimensional nature of the interactive grid matrix of FIG. 1 in a working example of NBA stars.

FIG. 8 is a wireframe block diagram representation of the three-dimensional interactive navigation grid matrix of video content shown in the screenshot of FIG. 7.

FIG. 9 is another expanded portioned screenshot from the video of FIG. 7 to illustrate selection of a particular node (video snippets of LeBron James' dunks) from a container in the chapter labeled “LeBron James”, sub-chapter “Dunks”.

FIG. 10 shows a selected video snippet from the selected node of FIG. 9, a video instance of a compendium of dunks from the node source.

FIG. 11 shows a node to container or container to node rendering to illustrate how selection of a given node or a given container may cause initiation of a hierarchical search (e.g., deeper structural drill down search) to display one or more new containers related to the selected node or container, according to the example embodiments.

FIG. 12 is a wireframe diagram of an example display of an interactive 3D grid 1000 to illustrate a process for a user to initiate deeper enhanced multi-dimensional video content search, according to the example embodiments.

FIG. 13 is a wireframe diagram of an example display view of a multi-grid arrangement after selecting grid navigation controls and search settings button in FIG. 12 to illustrate a potential application thereof, according to the example embodiments.

While the disclosed subject matter is susceptible to various modifications and alternative forms, the drawings illustrate specific implementations described in detail by way of example. It should be understood, however, that the description herein of specific examples is not intended to limit that which is claimed to the particular forms disclosed, but on the contrary, the intention is to cover all modifications, equivalents, and alternatives falling within the spirit and scope of the appended claims.

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

As used herein, the phrase “pre-rendered, non-live video content” may refer to video material that is fully created, edited, and processed in advance before being distributed or viewed. Unlike live video, which is broadcast in real-time as events occur, pre-rendered content is produced, finalized, and stored for playback at a later time. By “pre-rendered”, this means the video may be generated and finalized ahead of time, often involving editing, visual effects, color grading, or other post-production processes. This contrasts with real-time rendering, like in live streams or interactive video games, where visuals are generated on the fly. By “non-live”, this means that the content is not recorded or broadcast in real-time. It is pre-recorded and can be watched on-demand, such as in movies, TV shows, or pre-produced web series.

As used herein, the term video snippet may include any of a singular instance of a video element or frame constituted by a series of video bits (also referred to as a video file), a series of video frames constituting a video highlight, and a full video rendering. Video snippets may thus be understood as short, curated segments of a larger video work. They may serve as building blocks within nodes that capture key moments or relevant content portions for quick preview and discovery across the 3D interactive grid. Snippets may be optimized for fast loading and efficient consumption in various applications and plug-ins employing the example methodology described hereafter.

As used herein, the term node may defined as a searchable instance in one of the containers, with the node being composed of one or more instances of video snippets, the metadata corresponding to each of the one or more instances of video snippets that forms the snippet, and a reference to a source for each instance of a video snippet of content. A node may thus comprise one or more instances of video or media snippets, including but not limited to video, images, audio, or text, each accompanied by metadata and references to their source. A node may also be any scannable or digitally accessible entity, including, for example, QR codes, barcodes, NFC tags, or dynamically generated URLs that reference digital content. Metadata associated with a node may include hashtags, geotags (geolocation data), timestamps, and other descriptors that may facilitate dynamic linking and content discovery.

As used herein, a container in a basic understanding represents a drawer or collection of nodes, with one or more containers assigned to a given sub-chapter in the interactive navigation grid matrix. However, as will see hereafter, a container may take many forms.

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Additionally, a “computing device” as used hereafter encompasses any of a smart device, a firewall, a router, and a network such as a LAN/WAN. As used herein, a “smart device” is an electronic device, generally connected to other devices or networks via different wireless protocols such as Bluetooth, NFC, WiFi, ISDN, 3G, 4G, 5G etc., that can operate to some extent interactively and autonomously. Smart devices include but are not limited to smartphones, PCs, laptops, phablets and tablets, smartwatches, smart bands and smart key chains. A smart device can also refer to a ubiquitous computing device that exhibits some properties of ubiquitous computing including—although not necessarily—artificial intelligence. Smart devices can be designed to support a variety of form factors, a range of properties pertaining to ubiquitous computing and to be used in three primary system environments: physical world, human-centered environments, and distributed computing environments.

As used herein, the term “cloud” or phrase “cloud computing” means storing and accessing data and programs over the Internet instead of a computing device's hard drive. The cloud is a metaphor for the Internet.

Further, and as used herein, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, any kind of database object described herein can be implemented as single databases, a distributed database, a collection of distributed databases, a database with redundant online or offline backups or other redundancies, etc., and might include a distributed database or storage network and associated processing intelligence.

The computer system(s), device(s), method(s), computer program product(s) and the like, as described in the following example embodiments, may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means or the like. In general, any device(s) or means capable of implementing the methodology illustrated herein can be used to implement the various aspects of the example embodiments.

Computer program code for carrying out operations for aspects or embodiments of the present invention may be written in any combination of one or more programming languages, including a programming language such as JAVASCRIPT®, JAVA®, SQL™, PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computing device, partly on the user's computing device, as a stand-alone software package, partly on the user's computing device and partly on a remote computer or entirely on the remote computer or server. In the latter scenario, the remote computer may be connected to the user's computing device through any type of network, including a LAN or WAN, or the connection may be made to an external computer (for example, through the Internet using an Internet Service Provider).

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

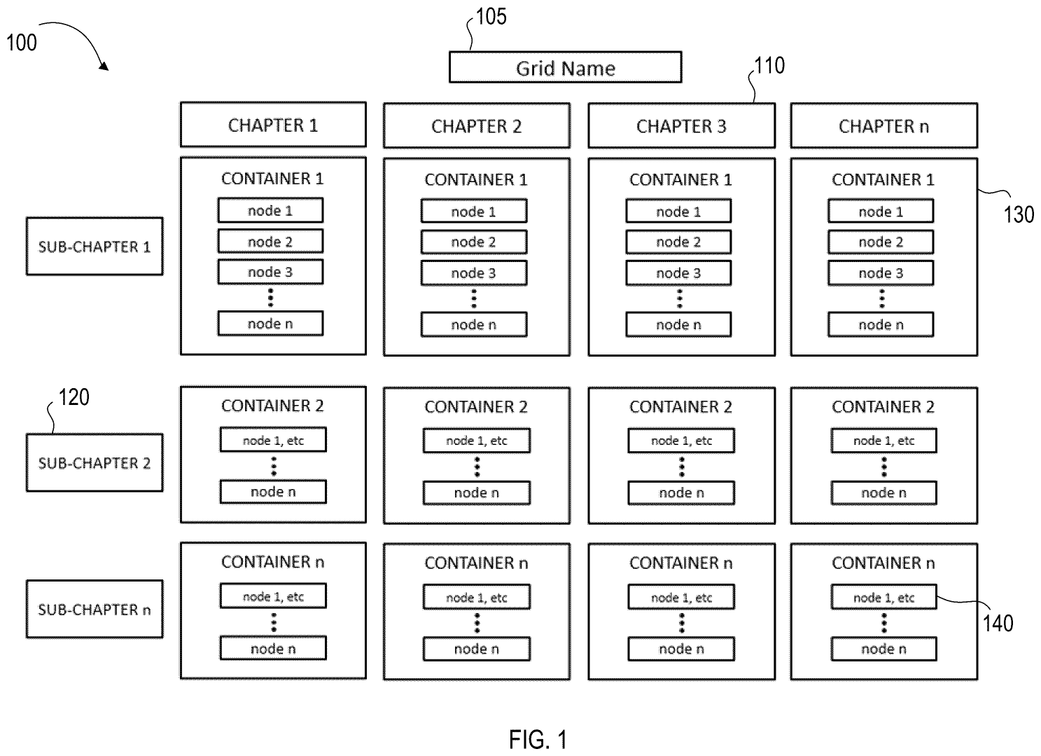

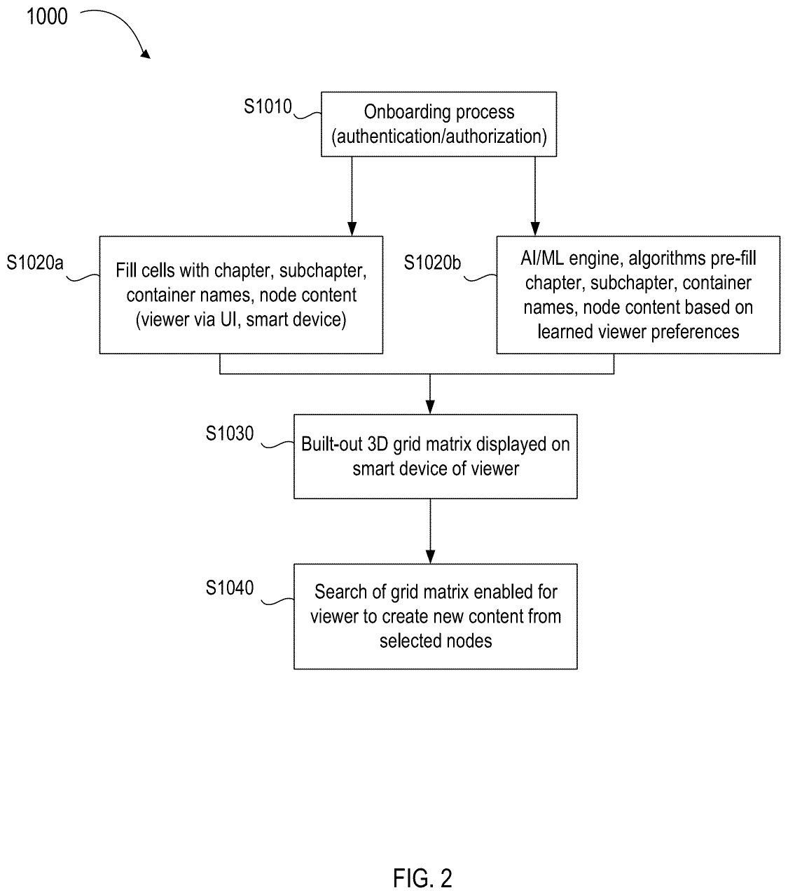

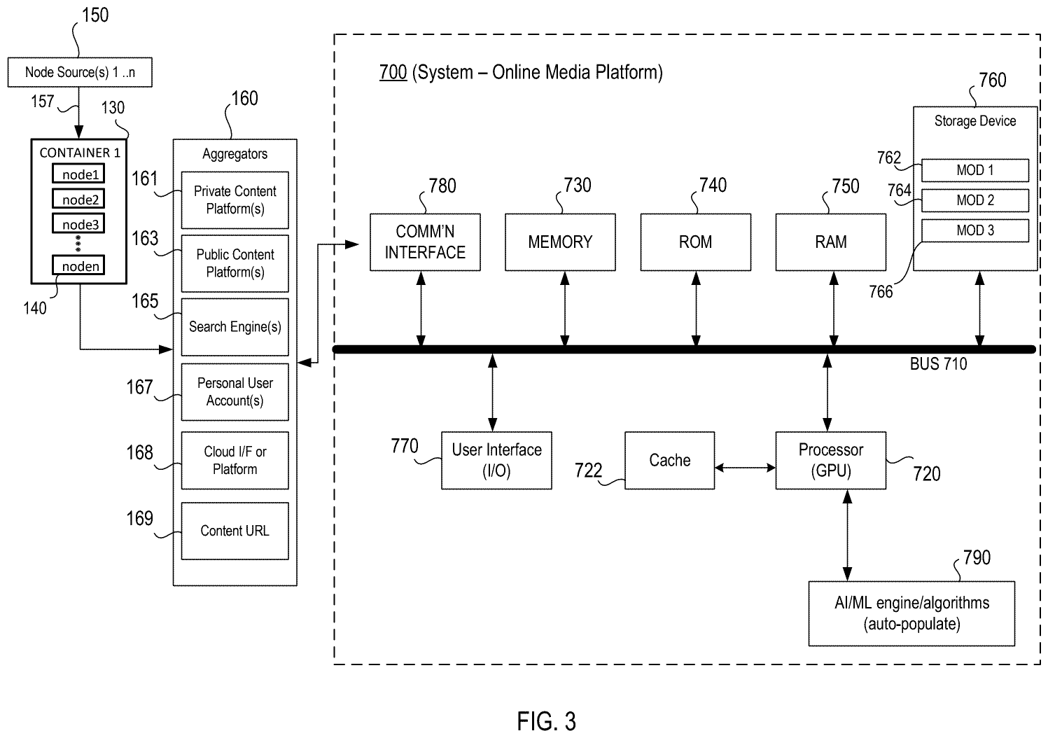

FIG. 1 is a block diagram representation of a three-dimensional interactive navigation grid matrix of video content according to the example embodiments; FIG. 2 a flow diagram to describe a method for performing a multi-dimensional search of video content accessible by a viewer thereof for the interactive navigation grid matrix of FIG. 1, and FIG. 3 shows a system for performing the multi-dimensional search method of FIG. 2.

Referring now to FIG. 2, with occasional reference to FIGS. 1 and 3, there is shown a method 1000 according to the example embodiments, namely a method, which is executed by one or more computing devices of system 700 in conjunction with user interface 770 (which could be accessed via a smart device of a viewer) in order to perform a multi-dimensional search of video content accessible by a viewer thereof via an interactive navigation grid matrix 100. The grid matrix 100 is displayed via the user interface to the viewer (such as on his or her smart device).

Initially, a credentialling operation or onboarding process (S1010) needs to occur for the viewer to have access to the online media platform (embodied by system 700) for building out and searching the grid matrix. This includes well known authentication and licensing approvals (for copyrighted content) and as such is not described in detail herein.

Via the user interface 770 on the viewer's smart device, the viewer may be prompted (with menu load and edit commands, etc.) to fill empty cells of the grid matrix 100 (S1020a) with the various names (chapter 110, sub-chapter 120), and acquire node 140 content (from node sources 150) via aggregators 160 to build out containers 130. The node source 150 video content accumulated by a given aggregator 160 is accessed by system 700 over a communication interface 780 (digital connections). Aggregators 160 of content include but are not limited to private content platforms 161, public content platforms 163 (YouTube), search engines 165 (GOOGLE, BING, etc.), Personal User Accounts 167 (such as those of system 700), by a cloud interface or platform 168 such as hyperscalers AWS and AZURE by Microsoft, and direct content URLs 169.

Recall that node 140 can be represented by any scannable entity such as a QR code or a bar code that references a source of the digital content. Hashtags can also be an element of a node or node link 157, such as the metadata that goes with a scannable entity such as a QR code. What is captured within the QR code could be hashtags.

In particular, via a user interface (UI), the viewer may insert the following: (a) chapter 110 names of the video content, (b) sub-chapter 120 names associated with each chapter, (c) containers 130 of video content associated for each subchapter 120 name, and (d) nodes 140 of video snippets associated with each container 130 under a given subchapter 120 name. As shown in FIG. 1, the chapter 110 and sub-chapter 120 names form headers of empty cells (to be filled) for 2 dimensions of the interactive navigation grid matrix 100 (multiple row by multiple column).

Alternatively, an AI/ML engine 790 iterating algorithms and in communication with system processor 720 (such as a GPU), may pre-fill the cells (S1020b) to build out the grid matrix 100. This could be done based on past or learned viewer preferences. In operation in one example, AI/ML engine 790 could be an API that provides pre-trained machine learning models that automatically recognize a vast number of objects, places, and actions in both stored and streaming video, so as to auto-populate the grid matrix 100 for the viewer.

Once the grid matrix 100 is populated/filled with video content, it may be displayed on the viewer's smart device (S1030), via the user interface 770, as an enhanced three-dimensional (3D) interactive navigation grid matrix. Namely, each container 130 represents the third dimension of the grid matrix 100 accessible within each subchapter 120 of a given chapter 110. Additionally, each node 140 represents one or more instances of video snippets accessible within its corresponding container 130 of a given subchapter 120.

Within the displayed grid matrix 100, the user is thus able to conduct a multi-dimensional search (S1040) of video content across all three dimensions of the grid matrix 100. In another example, the viewer can perform a structured drill-down to search all nodes 140 of a given container 130. Each node 140 is composed of one or more instances of video snippets, the metadata corresponding to each of the one or more instances of video snippets, and a reference to a source of each instance of a video snippet of content.

In a commercial manifestation, a commercial platform based on the example computer system(s) 700 and computer-implemented method 1000 described above and more hereafter includes technology and digital offerings (e.g. website, mobile application, non-transitory, computer-readable information storage media, tools, etc.). In one example, the commercial platform includes a downloadable mobile app. The mobile app (which may be subscription-based) is designed to provide subscribers with access to searchable video content via a grid matrix structure.

In one example, the commercial platform based on the example computer system 700 and computer-implemented method 1000 may be directed to multiple sales channels, including but not limited to: (a) B2C direct via the mobile app downloaded from a digital distribution service such as the GOOGLE PLAY™, AMAZON® Appstore and/or App Store by APPLE®; (b) a B2B relationship whereby applications may be licensed and offered under a designated brand; and (c) a B2B relationship whereby the licensing entity rebrands the applications for integration into their product suite.

Referring now to FIG. 3, system 700 (which may be representative of one configuration for an online media platform) is shown for example purposes as a basic general-purpose computer system (or computing device) to practice the concepts, method 1000, and techniques disclosed. System 700 includes a processing unit (GPU, CPU or processor) 720 and a system bus 710 that couples various system components including the system memory 730 such as read only memory (ROM) 740 and random access memory (RAM) 750 to the processor 720. System 700 can include a cache 722 of high-speed memory connected directly with, in close proximity to, or integrated as part of the processor 720.

The system 700 copies data from the memory 730 and/or the storage device 760 to the cache 722 for quick access by the processor 720. In this way, the cache 722 provides a performance boost that avoids processor 720 delays while waiting for data. These and other modules can control or be configured to control the processor 720 to perform various operations or actions.

Other system memory 730 may be available for use as well. The memory 730 can include multiple different types of memory with different performance characteristics. It can be appreciated that method 1000 may be iterated on a computing device or system 700 with more than one processor 720 or on a group or cluster of computing devices networked together to provide greater processing capability.

The processor 720 can include any general-purpose processor and a hardware module or software module, such as module 1 762 (which may be an ingestion software module which is programmed to provide, via the user interface 770, one of automatically populated cells of video content or fillable cells (performing part of S1020a/b) so as to enable the viewer to insert video content therein. Module 2 764 may be embodied as an insertion module programmed to auto-populate, or receive insertions by the viewer, for the video content so as to build out the interactive navigation grid matrix by chapter, subchapter, container, node (performing part of S1020a/b). Module 3 766 may be embodied as a display module programmed, via the user interface 770, to display an enhanced three-dimensional interactive navigation grid matrix 100 to the viewer. Each of module 1 762, module 2 764, and module 3 766 may be stored in a storage device 760, and configured to control the processor 720 as well as a special-purpose processor where software instructions are incorporated into the processor.

The processor 720 may be a self-contained computing system, containing multiple cores or processors, a bus, memory controller, cache, etc. A multi-core processor may be symmetric or asymmetric. The processor 720 can include multiple processors, such as a system having multiple, physically separate processors in different sockets, or a system having multiple processor cores on a single physical chip.

Similarly, the processor 720 can include multiple distributed processors located in multiple separate computing devices, but working together such as via a communications network. Multiple processors or processor cores can share resources, such as memory 730 or the cache 722, or can operate using independent resources. The processor 720 can include one or more of a state machine, an application specific integrated circuit (ASIC), or a programmable gate array (PGA) including a field PGA.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up.

The computing device 700 further includes storage devices 760 or computer-readable storage media such as a hard disk drive, a magnetic disk drive, an optical disk drive, tape drive, solid-state drive, RAM drive, removable storage devices, redundant array of inexpensive disks (RAID), hybrid storage device, or the like. The storage device 760 can include software modules 762, 764, 766 for controlling the processor 720.

The system 700 can include other hardware or software modules. The storage device 760 is connected to the system bus 710 by a drive interface. The drives and associated computer-readable storage devices provide nonvolatile storage of computer-readable instructions, data structures, program modules and other data for the computing device 700. In one aspect, a hardware module that performs a particular function includes the software component stored in a tangible computer-readable storage device in connection with the necessary hardware components, such as the processor 720, bus 710, display 770, and so forth, to carry out a particular function. In another aspect, the system can use a processor and computer-readable storage device to store instructions which, when executed by the processor, cause the processor to perform operations, a method or other specific actions.

The basic components and appropriate variations can be modified depending on the type of device, such as whether the device 700 is a small, handheld computing device, a desktop computer, or a computer server. When the processor 720 executes instructions to perform “operations”, the processor 720 can perform the operations directly and/or facilitate, direct, or cooperate with another device or component to perform the operations.

Although the exemplary computer system 700 employs a hard disk 760, other types of computer-readable storage devices which can store data that are accessible by a computer, such as magnetic cassettes, flash memory cards, digital versatile disks (DVDs), cartridges, random access memories (RAMs) 750, read only memory (ROM) 740, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, user interface 770 represents any number of input and output (I/O) mechanisms. For example, a smart electronic device (smartphone, tablet, PDA and the like) can be accessed for input using a touch screen or pointing device (e.g., a mouse). Output via the user interface 770 can be triggered by a user's finger or with a cursor of a mouse/touch screen, or with the viewer's eyes when the user interface 770 includes an eye tracker. Alternatively, functions or outputs of the system 700 graphically shown on a display of the viewer's smart device can be triggered based on a user's facial or physical expression where the user interface 770 includes or can access (on the viewer's smart device) a camera with appropriate gesture tracking technology, with voice where the user interface 770 includes or can access (on the viewer's smart device) a microphone with appropriate voice recognition technology, or by thoughts where the smart device includes a brain-computer interface to which access is possible via the user interface 770.

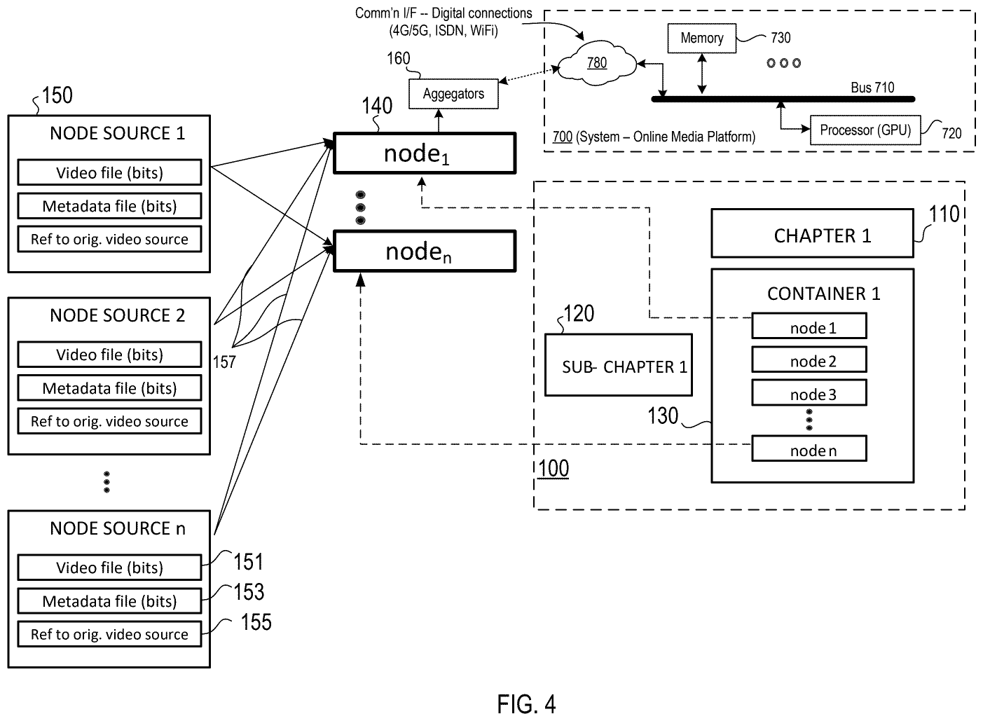

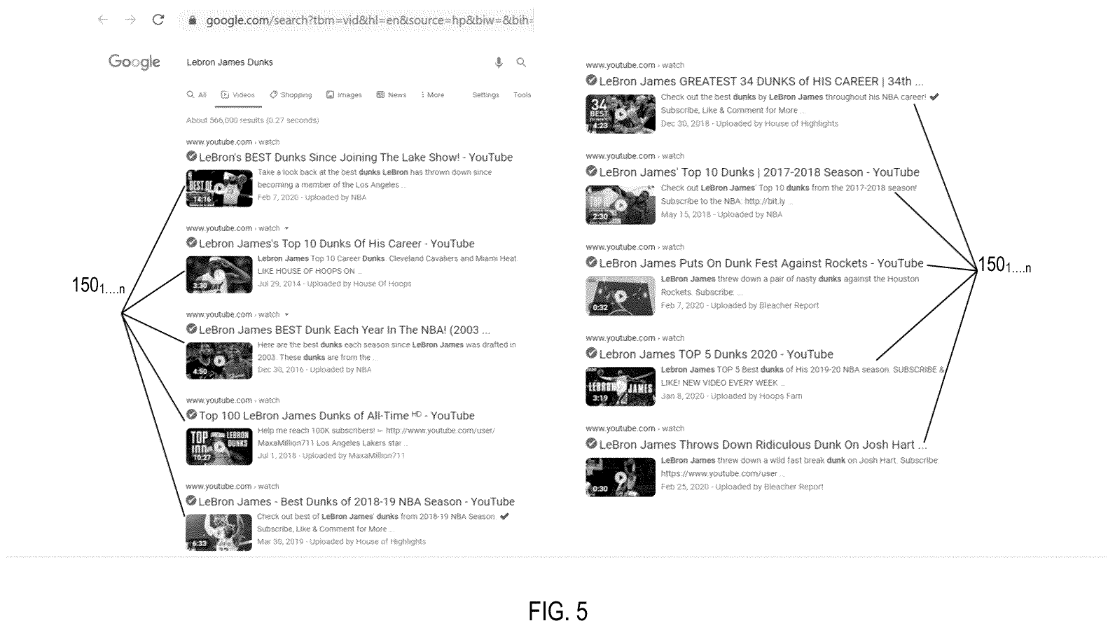

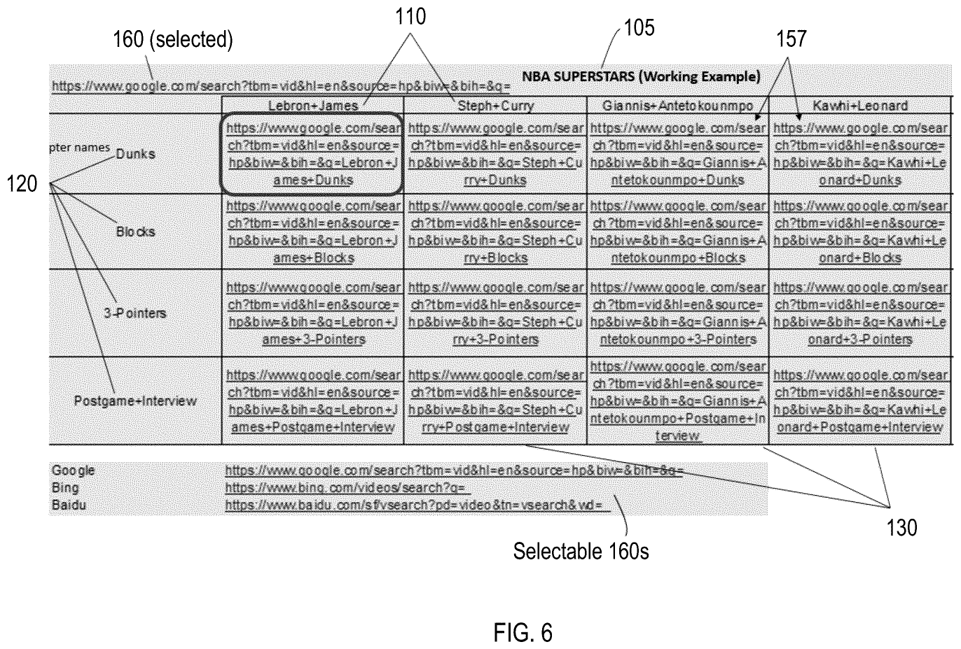

FIG. 4 is block diagram to describe how video content from node sources 150 is aggregated for digital transmission via the communication interface 780 to the online media platform embodied by the system 700 shown in FIG. 3. FIG. 5 is a screenshot of an aggregator 160's collection of node sources 150, where the aggregator 160 shown in the screenshot is embodied as a search engine. FIG. 6 is a screenshot of an excel file which shows the functional representation of the grid matrix of FIG. 1 in terms of its constituent components. FIGS. 4 to 6 illustrate functionally, with greater detail, how video content for nodes 140 of a container 130 is accessed from a vast plurality of node sources 150 accumulated at an aggregator 160.

Referring to FIG. 4, the left side shows an expanded breakout for node 1 and node n from the interactive navigation grid matrix 100. The video content from each node source 150 is accumulated by a given aggregator 160 (see FIG. 6), as previously discussed. A given aggregator 160 could be embodied as a search engine as shown in FIG. 6, or by a plurality of node feeds, for example) This video content from these aggregators 160 is then accessed by system 700 over a communication interface 780 (digital connections).

Recall that node 140 can be represented by any scannable entity such as a QR code or a bar code that references a source of the digital content. One or more hashtags can also be an element of a node 140 or node link 157, such as the metadata that goes with a scannable entity such as a QR code. What is thus captured within any QR code could be one or more hashtags.

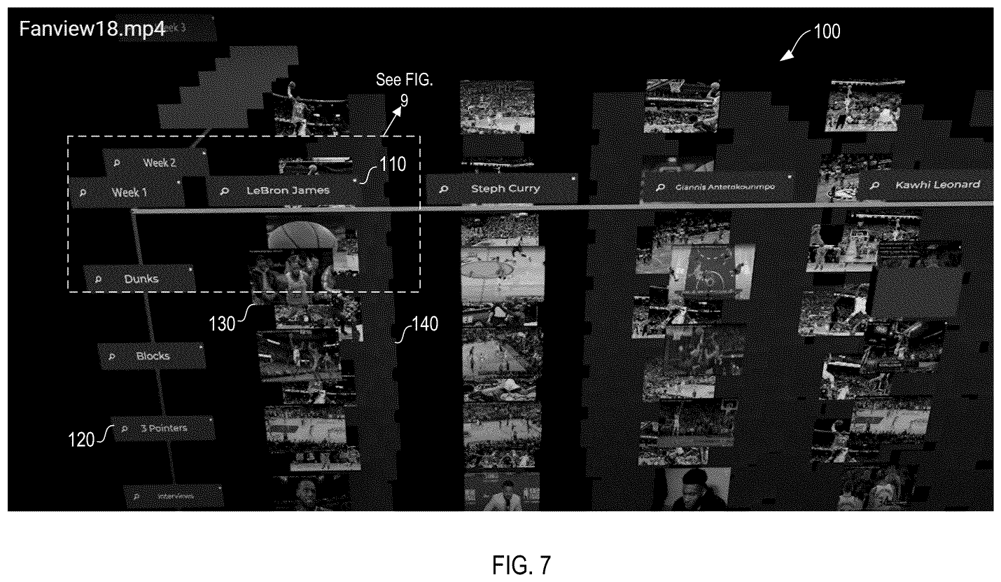

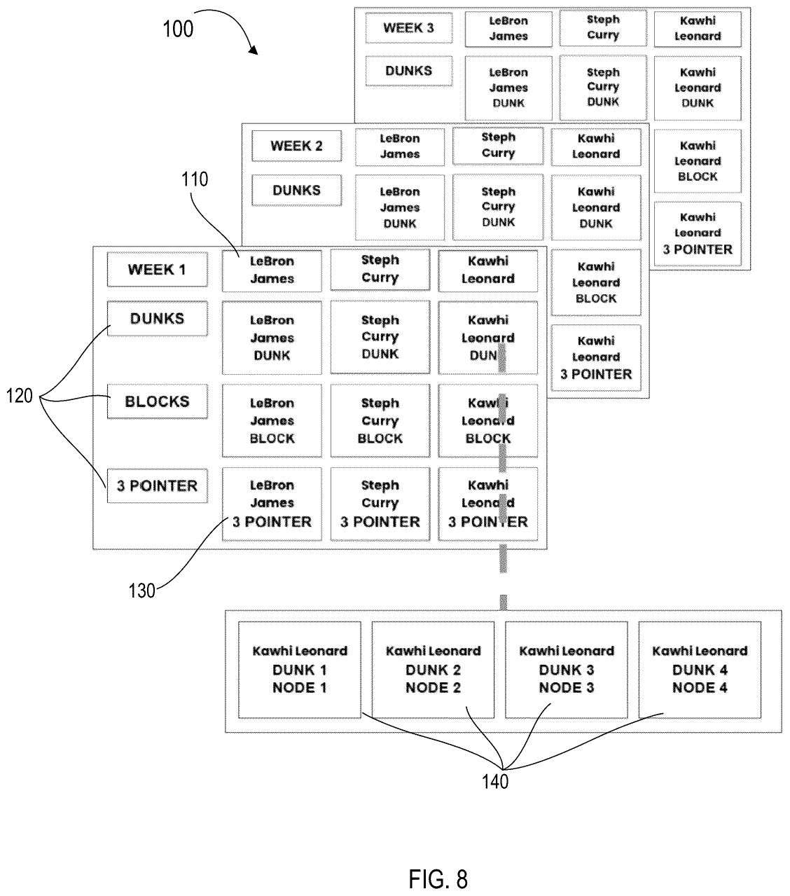

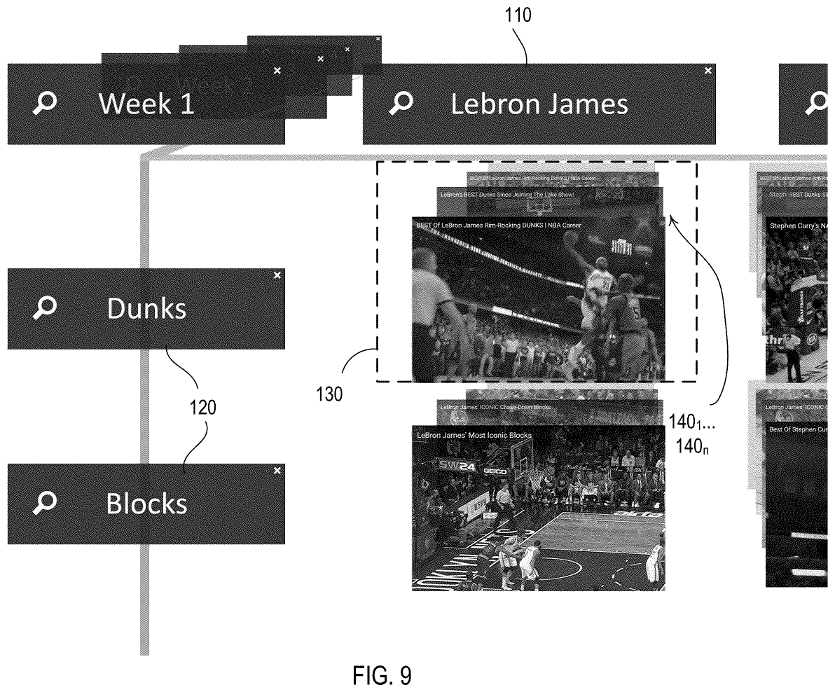

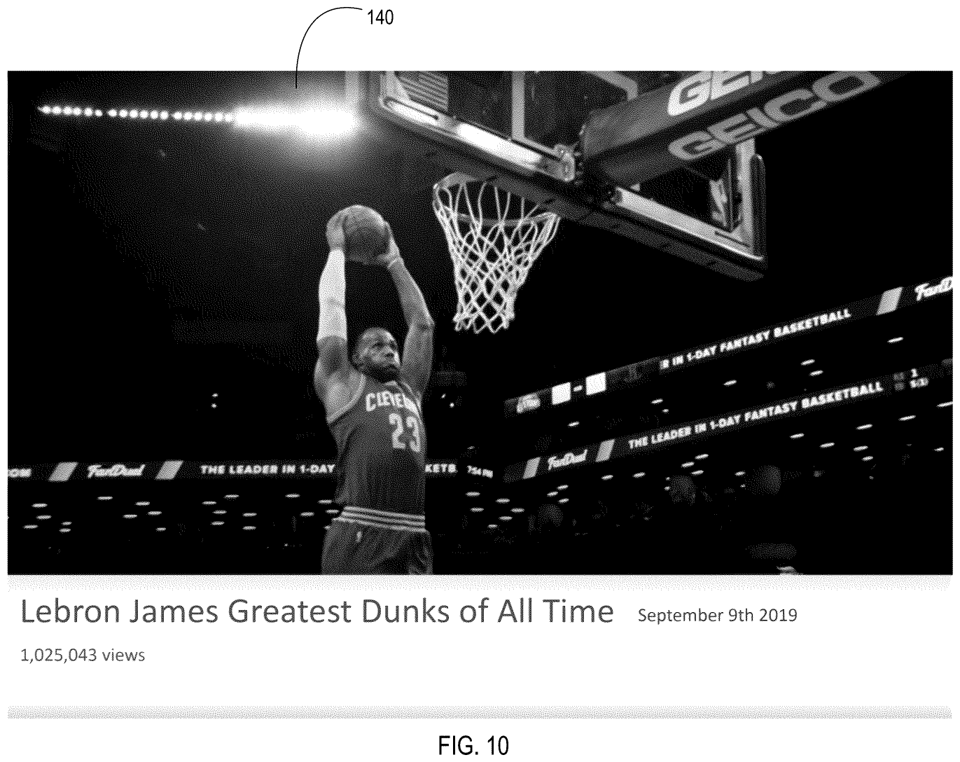

FIGS. 7 to 10 provide a working example of the method and system as rendered in an instructional video by Applicant. In FIG. 7 the screenshot of a video shows the 3-dimensional nature of the interactive grid matrix of FIG. 1. This particular screenshot shows a grid matrix of a series of NBA stars, with the chapter, subchapter, container and node configuration previously described above. FIG. 8 shows the wireframe block diagram that is shown by the screenshot of FIG. 7. Additionally, FIG. 9 is another expanded portioned screenshot from the video of FIG. 7 to illustrate selection of a particular node 140 (video snippets of LeBron James' dunks) from a container 130 in the chapter 110 labeled “LeBron James”, sub-chapter 120 labeled as “Dunks”. FIG. 10 shows a selected video snippet from the selected node 140 from FIG. 9, namely a video instance that is a compendium of dunks from the node source.

As will be described hereafter, and in some embodiments, the example method and system for enabling a multi-dimensional by displaying the 3D grid via the user interface allows the user to select of a particular node, (or a particular container of nodes) to trigger an automatic hierarchical search to display related video content to the selected node or containers (such as new nodes, new containers, one or more different grids, etc.). This hierarchical search within the 3D grid may be understood generally as an advanced content discovery process utilizing the hierarchical organization of the chapters, subchapters, containers, and nodes. The enhanced multi-dimensional search allows users to perform hierarchical searches across multiple dimensions, based on one or more of keywords, metadata, temporal context, geographic information, and user interaction history, for example. This may enable a richer, more nuanced discovery experiences within, for example, software apps and via third-party plug-ins that employ or have access to the 3D grid capabilities.

Some example multi-dimensional searches within the 3D grid described herein may be, for example: (a) a search of sports content, such as a multi-dimensional search in an NFL app that allows filtering by game period, team, and player performance for accessing video content with detailed play analysis; and/or (b) within a movie streaming app, searching within the Movie Trailers chapter by combining genre, release date, and user ratings; and/or (c) in a news aggregator app, a search that filters World News content based on geographic region, publication timestamp, and topic (e.g., “economic trends”); and/or (d) in a gaming portal, a search that blends keywords like tournament with filters for game genre (e.g., FPS) and live versus on-demand status; and/or (e) within a user-generated content app, a search tool that enables users to combine hashtags, geographic metadata, and engagement metrics (likes, views) to discover trending vlogs or tutorials.

Accordingly, the above may clarify how each of various elements within the 3D grid may function to offer an interactive media system. These examples also may illustrate a variety of practical applications in software apps as well as through third-party plug-ins, ultimately facilitating robust video search and discovery across diverse content categories and devices.

In some embodiments, the chapter may be understood as a high-level category that organizes video content into broad, thematic segments. In the example three dimensional grid the chapters serve as the primary navigation headers that allow users to quickly identify and access the main content domains (for example, sports, entertainment, news, etc.). Selected examples may include such as a chapter titled “NFL Highlights” groups all football-related content; a chapter titled “Movie Trailers” that aggregates film previews; a chapter titled “World News” that pulls together international news clips; a chapter titled “Science Documentaries” that curate's videos on scientific discoveries; a chapter titled “Vlogs” where personal video blogs are organized, etc., and the like.

In some embodiments, the subchapter may be understood as a means to further refines the classification within a chapter by breaking the broad topic into more focused topics or genres. Subchapters may provide additional granularity, allowing users of the 3D grid to drill down into specific areas of interest. Example subchapters within each of the chapters above may be as follows: within the NFL Highlights chapter, subchapters such as “Quarterback Performances” or “Defensive Plays” to refine the search; within “Movie Trailers”, subchapters like “Action Thrillers” or “Family Films” to segment the trailers by genre; within the World News chapter, subchapters such as “Political News” or “Economic Reports” to segment the news; within Science Documentaries chapter, subchapters like “Space Exploration” or “Medical Innovations” on an educational platform; within the Vlogs chapter, subchapters such as “Travel Vlogs” or “Tech Reviews” in a user-generated content application, and the like.

In some embodiments, the container may be understood as a spatial grouping that holds one or more nodes within the structured grid. Each subchapter may be configured with one or more containers, as previously shown. The container acts as a “drawer” or a block that bundles related video content, representing an additional, third dimension to the navigational hierarchy. Thus, for one or more of the subchapters in the NFL Highlights chapter, there might be a container displaying “Last-Minute Game-Winning Plays”; similarly for the Action Thrillers subchapter there may be a container showing “New Releases This Week”; a container for “Breaking Political News” in the Political News subchapter; a container for “Recent Space Missions” under the Space Exploration subchapter; a container titled “Trending Tech Reviews” within the Travel Vlogs subchapter, and so on.

In some embodiments, the node may be understood as a fundamental, interactive element within a container. Each node typically includes one or more video snippets (short video segments) along with associated metadata (such as tags, titles, timestamps, and source information). In accordance with the example embodiments, clicking or tapping on a given node within the 3D grid may trigger the display of additional content or a deeper, hierarchical search. Example nodes corresponding to some of the above containers may include a node in the Last-Minute Game-Winning Plays container showing a 10-second clip of a last-minute touchdown, complete with player name and game details; a node displaying a movie trailer preview, with metadata such as release date and genre; a node featuring a 15-second breaking news clip with a headline and publication time; a node that provides a short clip from a space mission launch along with contextual annotations; a node flagged as “Popular Vlog” which includes a brief snippet from a travel video and user ratings.

In the example embodiments, the hierarchical search, upon node and/or container selection, is designed to operate in real time. For example, when a user selects a node of video content (e.g., video content such as pre-rendered, non-live program video content) or selects a particular container within the interactive 3D grid, the system immediately triggers a hierarchical search. This hierarchical search leverages the metadata associated with the video content of the selected node or container, such as tags, timestamps, geographic markers (geolocation data), and contextual attributes, in an effort to dynamically query and retrieve additional, related content. The newly populated containers and nodes may then displayed instantly within the present grid (single grid view), or viewed in different additional grids (multi-grid view), ensuring that the user experiences a seamless transition and consistently relevant content based on their initial interactions.

As such, the hierarchical search of video content can be understood as a structured drill-down search performed in real time based on the metadata associated with the selected node or container, where the metadata may include one, some or all of hashtags, timestamps, geolocation data, etc. The drill down search may be configured to retrieve all nodes in one or more given containers that are within one or more three-dimensional interactive grids (3D grids) linked to the video content associated with the selected node or selected container.

In some embodiments, the method and system processing is configured to process the pre-rendered, non-live program video content in real time. Moreover, a given 3D, upon a user-initiated event (e.g., selection of a node, selection of certain setting (such as changing chapters, subchapters, etc., changing setting to modify search and/or display, etc.) the grid is configured to dynamically re-populate the pre-rendered, non-live program video content in one or more containers. In some embodiments, instead of user-initiated events, dynamic re-population may be triggered by system automation, or via a trained model.

Upon node or container selection, the enhanced multi-dimensional search as embodied in a hierarchical, structured drill-down search protocol may be operable across all three dimensions of the presently displayed three dimensional interactive grid, and may be actionable across any different three dimensional interactive grids (3D grids) linked to the selected node or container.

Further in some embodiments, any container may be configured to be populated with nodes and associated video content in real time, from any source of video content. Example sources may include but are not limited to public sources of video content, private sources of video content, and grid manipulations (setting changes, modes, etc. selectable by the user for the 3D grid) via the user interface. In some implementations, grid manipulations via the user interface may one, some or all of structural changes, source node replacements, and container-level adjustments, for example.

In some embodiments, as the user selects a particular node in the 3D grid for a deeper structured drill-down search, the user interface may automatically display a nested sub-container. In some example, the nested sub-container may contain additional nodes that represent a lower layer of detail in the video content hierarchy. This is one way of describing a layered approach to enhanced navigation of a multi-dimensional search of the 3D grid.

In some embodiments, the structured drill-down search (hierarchical search) may be driven by contextual filtering. Contextual filtering may utilize metadata associated with the selected node to dynamically refine and narrow subsequent search results. Such a contextual filtering-based search may be performed in real time based on the metadata (using one or more of its associated hashtags, timestamps, geolocation data, etc.)

In some embodiments, the video content (such as pre-rendered, no-live video content) displayed across the 3D grid to enable the multi-dimensional search, or hierarchical search upon node or container selection by the user, may be categorized. For example, in some embodiments, the video content may be categorized into a predefined taxonomy, such that, upon selection of a node or of a container, the structured drill-down search is automatically restricted to display nodes within the same category.

In some embodiments, the structured drill-down search may include or otherwise employ a dynamic filtering mechanism (“dynamic filter”) as part of the system processing that generates and displays the 3D grid. In an example, the dynamic filter may be configured to adjust displayed nodes within containers of a 3D grid in real time based on real-time user preferences, or based on system-detected engagement metrics. In some implementations, the dynamic filter may be configured to sort nodes by attributes including at least one of relevance, chronology, and popularity.

In some embodiments, instead of or in addition to dynamic filtering, the structured drill-down search may use or otherwise incorporate one (or both) of spatial filtering and temporal filtering. These types of filtering may allow for the selection of video content nodes that have been optimized based on time of capture, or based on geographical context associated with the video content.

In some embodiments, system and method processing may be configured so as to reorder subsequent containers and nodes resultant in the structured drill-down search, based on historical user behavior and interaction patterns, such that the drill-down search may continuously optimize for user-specific content engagement.

As noted in previous embodiments, the 3D grid matrix is configured so as to repopulate dynamically by adjusting several data dimensions. In some implementations, this flexibility may be achieved through one of more of changes in chapters and subchapters, changing the source(s) of video data, modifying metadata that controls, presentation of content within the interactive grid, and reordering changes. By modularizing video content into chapters and sub-chapters, the grid can reorganize its structure on demand. For example, changing the hierarchical breakdown can reveal different video content layers or reorganize the presentation to emphasize new themes. For changing source data, in some implementations the system may switch between pre-recorded, static datasets and live data. This means that the same grid (or a given container therein) might display historical content at one moment and real-time content at another.

Additionally, the presentation of content within the interactive 3D grid isn't fixed, but may be adjusted by altering metadata. This metadata might include attributes like visual style, preferred layout, emphasis values, and even sorting orders. Further, the example system may support reordering of content nodes based on one or more of user interaction, updated metadata, or algorithmic re-ranking so that the most relevant video content is always prioritized. The 3D grid matrix may therefore serve as both a static repository and a dynamic interface, capable of repopulating itself according to the desired narrative or contextual updates.

In some embodiments, the interface and system processing may enable cross-referencing between grids. For example, within the example system, no node within a given container is limited to referring only back to its own interactive grid. Instead, any node that has been selected by the user can reference another 3D grid, effectively acting as a portal to related video content. As an example of inter-grid navigation, each node may have the capability to initiate a jump to a separate interactive grid (2D and/or 3D) that may be contextually related. This enables a deep, interconnected mapping of content, where a selected node might lead to an entirely different interactive grid matrix of content with its own structure and hierarchy. This may offer enhanced related content discovery, since by referencing other grids, the system may leverage the associative potential of its content. For example, a user exploring a particular subject might quickly switch contexts and view additional content layers that discuss complementary topics or extend the narrative in a different direction. As such, a cross-referencing capability may enrich the discovery process by breaking the limitation of a single grid and opening the path to multi-dimensional exploration.

In some embodiments, the use of contextual filtering within a given 3D grid (or even a 2D grid) to leverage metadata signals my help to ensure that the drill-down search initiated upon user selection on a given node or given container reveals content that is contextually relevant to the user's previous interactions. Additionally, the system's ability to categorize video content into predefined taxonomy (e.g., genres, topics, or themes) may able users to drill down intuitively within specific subject areas. The incorporation of spatial and/or temporal filtering in a deeper drill down search may facilitate the ability for users to drill down not only by subject matter, but also based on time-sensitive or location-based data, offering a more nuanced search experience. Further, the system's ability to reorder subsequent containers and nodes during search may support a personalized navigation by using user interaction data to dynamically adjust the order in which additional content is presented during the drill-down process. By dynamically filtering and sorting content, the system may be configured to present the most pertinent nodes and containers, thereby enhancing a user's discovery process.

As previously noted in some embodiments, any container may be populated in real-time from any source, such as from public sources, private sources, and from grid manipulations. This illustrates the system's flexibility in dynamically sourcing and displaying content within its interactive 3D grid. In practice, for example, each container (e.g., a visual or logical group in the grid interface that presents media or content) can be instantaneously populated with data from multiple and varied origins, depending on user interactions, contextual triggers, system parameters, and the like. This real-time population capability permits the user interface to be highly adaptive and responsive, ensuring that content remains fresh, relevant, and personalized irrespective of where it originates.

Example public sources that can feed a container, may include open web content and open data repositories for example. Open web content may include publicly available video streams and media from platforms such as YouTube®, VIMEO®, and news aggregators. Public APIs from social media networks and public data feeds (like weather updates or public event listings) may also serve as sources. Open data repositories may include government releases, public statistical datasets, or news services that offer APIs to pull the latest updates can provide real-time content updates for a container.

In some examples, public sources from which to feed the container may include proprietary media libraries, enterprise databases and intranets, and subscription-based on licensed content. Many organizations have internal proprietary content repositories such as corporate video archives, exclusive sports footage or behind-the-scenes media that can be integrated to ensure secure and private content delivery. Secure, internal databases and internets may include documents, training videos, or proprietary news feeds specific to an organization which can be dynamically pulled into the 3D grid. Content that is not publicly available but accessible via a license agreement or subscription can be integrated as a private source, ensuring only authorized users see the content.

Contains may be populated in real time using grid manipulations and dynamic content adjustments. In some embodiments, this may be done by way of structural changes, “source” node replacements and container-level adjustments, With structural changes, the system can “remap” a 3D grid by changing chapters, subchapters, or reorganizing the layout to emphasize different types or groups of content, which effectively acts as a source redefinition. For node replacement, the user or the system might choose to substitute one video content source (the originally selected source node for example) for another within a node; for example, switching between different camera angles or alternate takes that dynamically reflect evolving narratives or contextual shifts. Further, the system may be configured to alter the container's presentation by changing certain embedded video attributes, such as duration, thumbnail imagery, resolution, or supplementary metadata, for example, to better reflect current user interest or contextual relevance. This may imply that not only is the source of the content variable, but the manner in which it is presented (e.g., form and attributes) is also dynamically adjustable.

Accordingly, the example method and system may be configured to continuously (and in real-time) query various public and private sources, as well as leverages internal grid manipulations, to deliver a highly titrated media experience. This may ensure that every container, which is the basic building block of the interactive 3D grid, is always populated with content that is most relevant to the user, enhancing the overall user experience through a seamless blend of external data and more sophisticated algorithmic presentation.

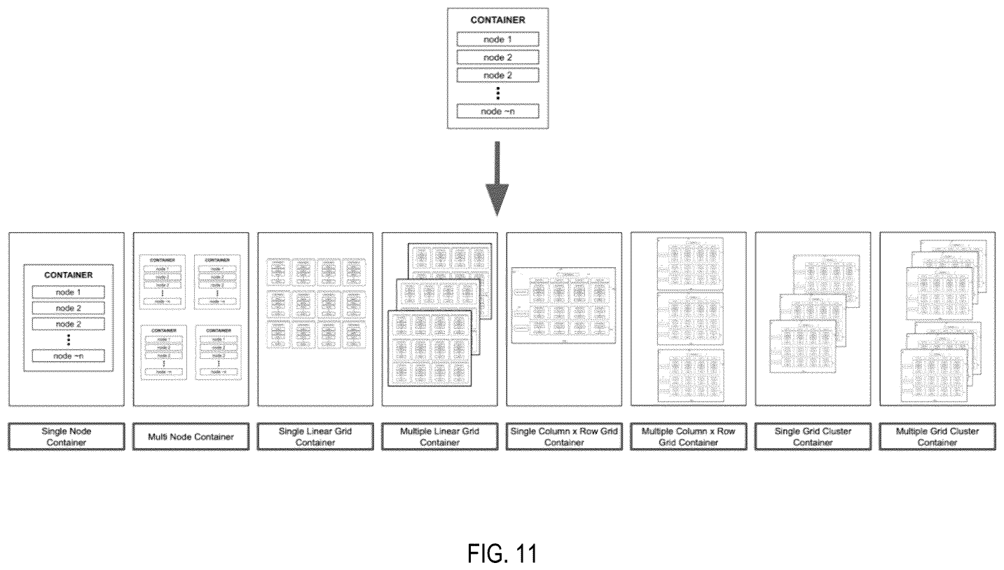

FIG. 11 shows a node to container or container to node rendering to illustrate how selection of a given node or a given container may cause the initiation of the hierarchical search (e.g., deeper structural drill down search) to display one or more new containers related to the selected node or container, accessible in a presently displayed 3D grid, displayed in multiple, different 3D grids related to the video content of the selected node or container. FIG. 11 also demonstrates the wider how a container in fact may represent any of a single container, a set of containers, a single grid, multi-grid cluster, etc.

Referring, now to FIG. 11 there is shown an illustration of a “node to container to node to container” user experience, In this paradigm, individual items (nodes) are grouped into organized clusters (containers). When a user selects a node from one container, the interface dynamically transitions to present, at the very least, another “new” container—a deeper drill-down or an associated set of new content nodes, enabling a rich, hierarchical exploration. This fluid, iterative process may enhance engagement and personalization across devices like phones, TVs, and VR systems.

The container herein has been defined as a “drawer” or collection that holds a single node or multiple nodes. Containers are integral parts of the interactive navigation grid matrix and may be linked to one or more sub-chapters. But a container may be embodied in a variety of different container configurations within an interactive grid matrix. For example, a container may be (a) a single one-dimensional linear grid container; (b) a multiple linear grid container; (c) a single column×row grid container (d) a multiple column×row grid container; (e) a single 3-dimensional grid cluster container; and (f) a multiple three-dimensional grid cluster container. This is shown in FIG. 11

As can be seen in FIG. 11, a container is not static. Containers may be dynamically reconfigured based on user interaction, system triggers, video source changes, and the like. According to the example embodiments, the container, whether linear, multi-dimensional, or 3D, may be dynamically re-populated and reconfigured in real time, for example, based on changes in user behavior, changes in content availability, via system algorithms, via a trained model, etc.

In a general operation, originally, (and as shown in various previous figures) the user may be first presented via the user interface with at least a high-level container that aggregates several nodes, for example, in a 3D grid displaying headlines, featured videos, or app icons, etc. “home screen.”. Next, upon selection of a given node or a given container in a present 3D grid (e.g., user tapping or clicking on a node within that container (say, a news story or a social media post), the user interface instantly “drills down” to display at least a single new container. As shown in FIG. 11, the new container may present or manifest in a number of different forms, such as a single container of nodes, multiple containers of nodes, as a single linear grid container, a multiple grid container, a single or multiple column×row (2D) grid container, a single 3D grid container or as multiple displayed 3D grid containers. In this light, as each is a visual or logical group in the user interface that presents media or content, each may represent a kind of container.

The new container might show detailed content, related media, or sub-categories tied to the selected node. As an illustration of further navigation, within this detailed new container, each node itself is selectable so as to open additional containers. This process can occur repeatedly to reveal deeper layers, such as extended content, additional related nodes, or rich multimedia data. Throughout the drill sown search, context is preserved. In other words, throughout the system preserves context through visual cues and metadata. For example, breadcrumbs, animations, or transitions may be provided to help the user understand how the new container relates to the previous container/node selected.

The following are selected examples of how the example methodology may be tailored to different content domains. A first example may be in the context of user-generated content. An example scenario here might be a social media feed. On a smartphone, the user sees an interactive 3D grid view of friend posts, photos, or status updates. Node selection occurs as a the user taps a post (node) to open a new container that displays the post's full details, including comments, likes, and shared media. Within this displayed view, further navigation may occur upon the user tapping a user's profile picture (node), so as to transition into another new container showing the user's full profile, with their past posts and multimedia content. This approach may allow users to fluidly transition from a feed overview to highly personalized content, driving deeper engagement and a more satisfying browsing experience.

A second example may be in the context of professional sports, such as within a sports information platform. On a TV, the user sees an interactive grid displaying team logos and current match highlights. Selecting a team logo (node) opens a new container that houses detailed team statistics, player profiles, and recent game footage. Further Navigation may be accomplished by clicking on a “highlight clip” node that transitions into another new container featuring multiple-angle replays, in-depth commentary, and historical game comparisons. The example method and system's application to sports may enable fans of teams to explore content in layers, from broad overviews to hyper-focused details, ultimately enhancing live game-day experiences and post-match analyses.

A third example may be in the context of news, such as within a dynamic news app. On a smartphone, the user sees an interactive, visually rich grid presenting top headlines as individual nodes. By way of the user tapping a headline (node) in the app, this opens a new container (within perhaps the present 3D grid or in another 3D grid) that displays the full news article, multimedia clips, and background information. Within the article container, interactive modules or “related news” nodes lead to additional containers (within the same grid or within additional interactive grids) with follow-up stories and expert analyses. This structure may enable readers an ability to explore news in a non-linear way, revealing deeper context and seamlessly branching into other relevant stories with associated video content, increasing reader engagement and retention.

A fourth example may be in the context of entertainment, such as a streaming service interface. On a TV, the interactive 3D grid might show theater-style posters for various TV shows and movies. User selection of a movie poster (node) transitions into a new container (in the same or a different grid) that provides movie details, trailers, cast information, and user reviews. For further navigation in the new movie details container for example, the use clicks on a related trailer (node) which may open in another new container for a high-definition viewing, complete with behind-the-scenes features and alternate cuts. Here, viewers may experience a visually compelling, layered exploration of content, making browsing more interactive and encouraging longer session times that translate into increased subscription and advertising revenue.

A fourth example may be in the context of entertainment on any of a smartphone, TV, and VR platform such as a VR headset. This scenario might be where a multi-platform gaming hub is presented to a user via a VR headset. Initially, the user is presented with a interactive 3D grid such as a 3D virtual lobby, where games are represented as floating nodes within an immersive grid. Selecting a game (node) transports the user into an interactive gaming dashboard container (new container) that displays in-game statistics, leaderboards, and live event feeds. From this dashboard, further navigation may be possible via tapping a level or mission node to open another new container featuring detailed walkthroughs, community-generated tips, or live multiplayer sessions. Whether on immersive VR or more traditional devices, by using the example method and/or system gamers can navigate between real-time content, community engagement, and gameplay tutorials seamlessly, thus enriching the overall gaming experience.

As such by enabling layered exploration, from broad overviews to detailed sub-content, the user interface of multi-dimensional search of interactive grids may deliver personalized, immersive experiences adaptable for user-generated content, sports, news, entertainment, and gaming across multiple devices. This may not only enhance user engagement but also may create opportunities for content monetization and deeper audience insights. By integrating the example method and system within various media domains, providers may be able to offer offering richly interactive experiences that surpass conventional linear interfaces for digital content discovery.

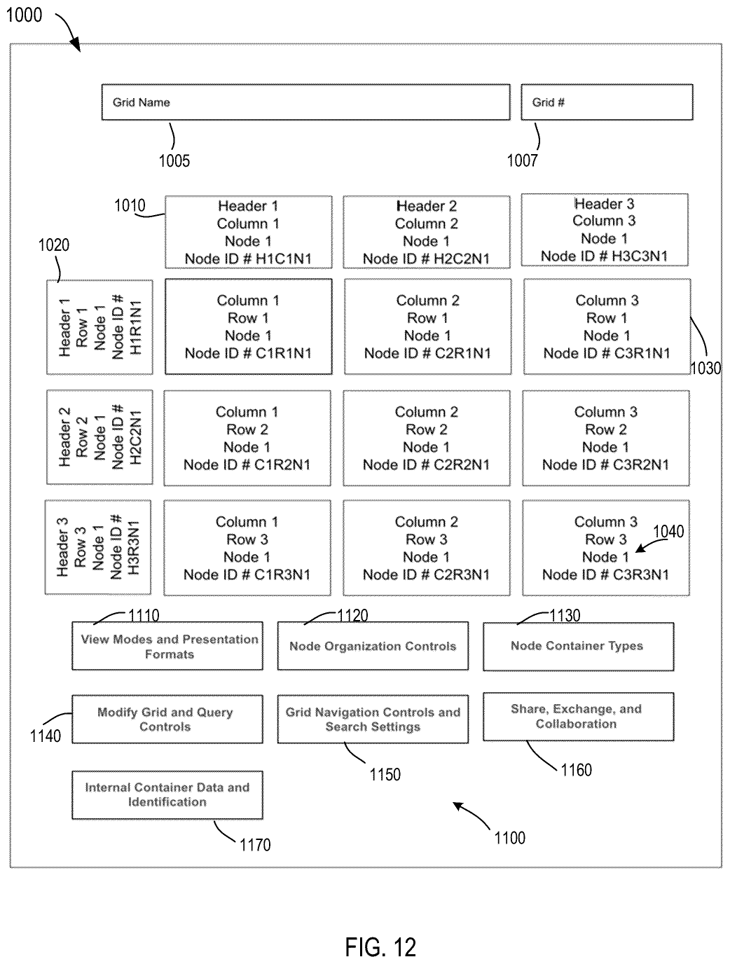

FIG. 12 is a wireframe diagram of an example display of an interactive 3D grid 1000 to illustrate a process for a user to initiate deeper enhanced multi-dimensional video content search and discovery experiences using controls within the user interface (UI) and user experience (UX) across smart devices such as smartphones, tablets, smart TV's and VR. The following discussion also offers a step-by-step description of how a user may initiate the hierarchical search (deeper, structured drill down search) from an original, core, or base grid 1000 and also how manipulating user settings such as filters, modified keywords, and personalized preferences, may result in multiple different video content search results and navigation paths within a multi-layer experience.

The grid 1000 in FIG. 12 includes the grid name 1005, a grid identification (grid #1007), headers (chapters 1010, subchapters 1020, containers 1030 and at least one node 1040 within each container 1030. In an example, the chapter column may have its own header ID (e.g., H1C1N1, H2C2N1, H3C3N1) and each subchapter row may have its own similarly marked header (e.g., H1R1N1, H2R2N1, H3R3N1). Additionally, within each container 1030, each node 1040 designating displayable video content (e.g., a video clip, image, or text snippet) may be labeled based on its column and row location (e.g., C1R1N1, C2R2N1, C3R3N1). Systematic labeling may offer precise addressing of any piece of video content in the grid 1000 for on-demand retrieval or updates.

A grid 1000 as displayed in the example wireframe diagram provides a clear, at-a-glance view of multiple video content items. For instance, in a basketball application, columns can be used to differentiate individual athletes (Column 1 might display content for Michael Jordan, Column 2 for Magic Johnson, and Column 3 for Kobe Bryant). Rows can represent different types of events or performance statistics (such as dunks, 3-pointers, assists). Because each node 1040 within a container 1030 may be uniquely labeled, the system may be scalable to accommodate hundreds of containers 1030 with nodes 1040 across several grid layers, providing an organized user interface that may be responsive even with a high volume of video content simultaneously available.

In some embodiments, users can transition, via selection of a node 1040 or a container 1030, from a high-level overview as embodied by grid 1000, to an in-depth hierarchical exploration in several steps. Below is just one example of how a user might interact with the example method and system, along with device-specific navigation paths and manipulated settings that may change the resulting search queries and content displays.

For initial interaction and grid engagement, in this example on a TV or tablet, when a user launches the application, a default, base or core grid 1000 may be displayed. For example, grid 1000 might occupy the full screen, showing thumbnails or short clips and predefined headers indicating categories (e.g., athletes, event types). If initializing interaction via a smartphone, a simplified version of the grid 1000 might presented in a responsive layout, with swipe gestures available to scroll horizontally and vertically.

The user may be exposed in initial video content. For example, grid 1000 may show video content extracted from a an original “source” node 1040 selected by the user, such as a highlight reel of a specific game event. The user may then use various navigation controls to initiate the hierarchical or deeper drill-down search. For example, using a using a TV remote, joystick or keyboard, arrow keys (or the joystick) may enable the user to navigate from one node 1040 to the next by pressing directional buttons. Upon selecting a specific node 1040 (e.g., highlighting a thumbnail representing Michael Jordan's dunk and then pressing an enter or select button, for example), the system recognizes interest in that specific content. If the user is using their smartphone or a tablet, the user may swipe to browse through the grid 1000 and when a desired container 1030 or node 1040 is tapped, a new detailed overlay (e.g., a display of one or more grids with new containers 1030 and hence new nodes 1040) may appear. In a VR environment, the user may employ gaze and gesture controls. For example, the user may look at or gesture toward a specific node 1040 (or container 1030); once focused on the gaze or gesture, a virtual panel may open showing extended information (e.g., a display of one or more grids with new containers 1030 and hence new nodes 1040). Further, the user may employ voice commands like “show more details” to trigger deeper structured video content searches.

Upon container 1030/node 1040 selection, the user interface may provide additional options for an enhanced, deeper, structured drill down search. For example, a control overlay such as the modify grid and query controls button 1140 may allow the user to modify the search criteria by adjusting keywords, metadata, or filters. For instance, if the selected node 1040 displays a dunk by Michael Jordan, the user may adjust the query to “Michael Jordan 3-pointers” or “highlight reels 1990s Basketball” by selecting filter icons. Button 1140 may also permit further grid modification and advanced filtering options, including, in this example, sorting by “Most Recent,” “Most Viewed,” or “Highest Rated”. For example, a user might decide to switch the filter from a default order to “Most Liked” to see the highest-rated performance clips.

When all search modifications have been confirmed, a container 1030 or node 1040 selection in grid 1000 may trigger advanced processing in the system. This triggering may utilize the node's unique identifier (e.g., C2R1N1) to reference its underlying metadata and update the search query for dynamic repopulation in a new displayed grid to enable a deeper, multi-layer search. The system may also dynamically construct additional search queries by combining the metadata (such as “Michael Jordan” and “dunk”) with user-defined parameters (e.g., viewing history, related keywords, additional filters).

As an example of repopulation in a grid new nodes 1040 or video may be automatically fetched and inserted into the grid. For example, a first column might now include additional episodes featuring Michael Jordan's top dunks; a second column might refresh with related events like game-winning assists.

The user interface, in some embodiments, may be configured to shift to a multi-grid view that displays not only one grid but several stacked layers (or side-by-side renditions) of grids. For example and using this basketball example, a first layer might be a grid focused on recently recorded live highlights from major broadcast networks. A second layer may be a grid containing user-generated video content detailing classic game moments, and a third layer may be a grid featuring professional analysis from sports network websites.

In some embodiments the user, via the user interface, may have the ability to perform iterative refinement via various navigation paths. For example, in a first scenario (TV Remote), a user navigates to a particular container 1030 or node 1040 depicting “Michael Jordan dunks” using the remote. They press the modify grid and query controls button 1140 to change the default filter to “Most Shares,” and update the default keyword to include “all-star game.” The grid 1000 automatically repopulates with a cluster of iconic dunks from similar events. The user may then press the grid navigation controls and search settings button 1150 to explore a related grid showcasing “Defensive Plays” by the same athlete.

In a second scenario (Smartphone/Tablet), the user taps a desired node 1040 in a basketball grid (such as in the format of grid 1000) that shows Olympic slam dunks. Using on-screen icons having similar functionality as the selectable buttons 1100 shown in FIG. 12, they may adjust the search query to emphasize “Olympic highlights” and enable a filter for “High-Resolution” content. The user interface shifts, populating new nodes 1040 with replays and slow-motion breakdowns. The user then might use a pinch-to-zoom for a more detailed view of a particular play, and might swipe to access a second layer (a new grid) featuring expert commentary.

In a third scenario (VR), and within a VR sports expo environment, a user dons a headset and sees a floating grid where the chapters 1010 (columns) display individual athletes and the subchapters 1020 (rows) represent event types. By gazing at a container 1030 labeled “Magic Johnson assists” and issuing a voice command “Show detailed analytics,” the user interface might bring up an augmented grid with historical data, live stats, and fan reactions. The user then may navigate laterally to compare this with “Kobe Bryant assists” in a separate grid context.

In some embodiments, as the user interacts with these dynamic nodes 1040, each selection may further refine the search history (e.g., within the deeper structured drill down search) and personalize subsequent video content refreshes. Thus user, as will be seen hereafter, may switch freely between different grid layers (inner grid navigation for detailed inspection, grid-to-grid (“multi-grid view) for lateral comparison, and container-to-container analysis for broader exploration) based on their evolving interests.

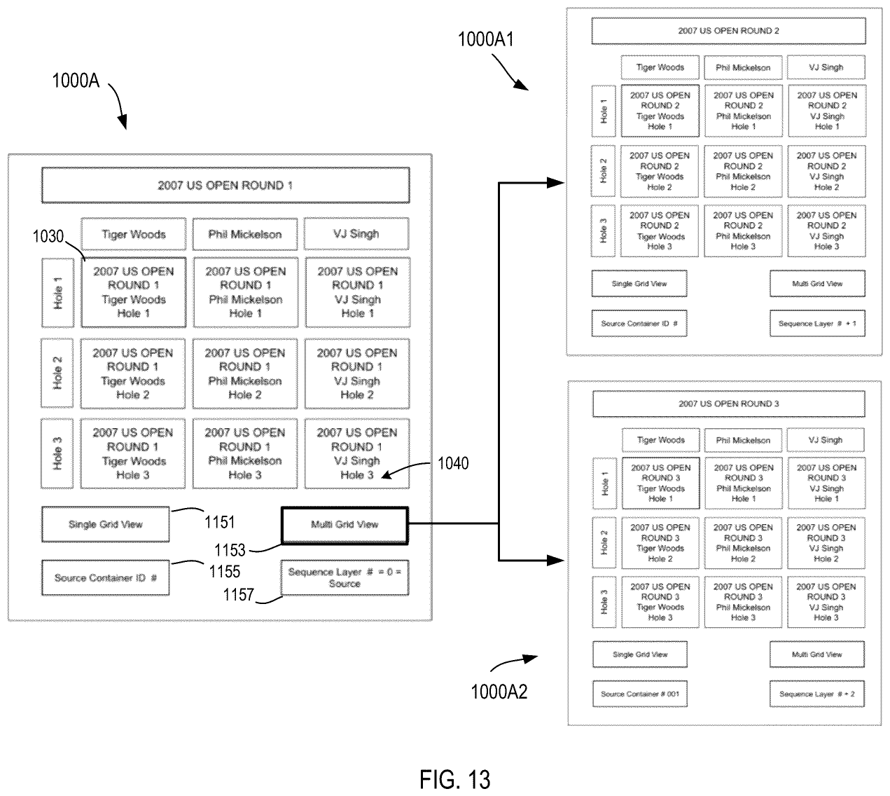

FIG. 13 is a wireframe diagram of an example display view of a multi-grid arrangement after selecting grid navigation controls and search settings button in FIG. 12 to illustrate a potential application thereof in the context of a golf tournament. In FIG. 13, the wireframe initially presents a column×row×container grid display (similar to as shown and described regarding FIGS. 1 to 10) for Round 1 of the 2007 US Open. Originally, the user had been presented a 3D grid with selected major tournaments (in the format of FIG. 12, for example) and it may be assumed for purposes of this example, that the user previously has selected a node 1040 in FIG. 12 which resulted in the grid 1000A to be displayed, similar to the format of an initially displayed default, base or core grid 1000 shown in FIG. 12. For example, the user then may have selected grid navigation controls and search settings button 1150 in FIG. 12 to generate and display the grid 1000A shown in FIG. 13 with selectable setting buttons thereon. These selectable buttons may include a single grid view button 1151, a multi-grid view button 1153, a source container ID # button 1155 and a sequence layer # source button 1157, for example.

Should the user select the single grid view button 1151, the user may isolate one specific tournament grid and focus solely on its internal structure. This mode 1151 may allow the user to drill down into a particular event—choosing a year and then selecting a hole to see finer details or associated content. Choosing the multi-grid view, in general, permits up to “n” grids to be visible concurrently, enabling side-by-side evaluation of performance trends or content differences across containers (in this case, rounds 1, 2, 3). The source container button 1155 and sequence layer button 1157 (here already selected for container ID #001 as the source container and layer #0 as the source sequence layer prior to conducting the deeper, drill-down search) may serve as the overarching elements that bring together all the grids. For example, these elements may be understood as the anchor point of the entire node and container based system, ensuring that regardless of the current view mode, every grid is a part of one unified dataset.

In one example, the first sequence layer (such as sequence layer #1, not shown) if selected, may provide a high-level arrangement of related grids to grid 1000A, listing tournaments, years, or perhaps a snapshot of overall performance. Sequence layer #1 may serve as a “starting point” from which further granularity is possible. In one example, once a primary node is selected from one of the grids displayed in sequence layer #1, a second sequence layer (such as sequence layer #2 not shown) if selected, might offer a more detailed breakdown. For example, after selecting a tournament (a container 1030 or a node 1040) from one of the grids resultant from sequence layer #1, the second sequence layer could present each hole's statistics, video highlights, or additional metadata. This layered approach may be configured to help users maintain context while drilling into details, mimicking a breadcrumb navigation where each “step” refines the search.

In this example, containers 1030 representing the third dimension in interactive grid 1000A each include selected video clips (nodes 1040) of video content featuring Tiger Woods, Phil Mickelson, and V J Singh over various holes of the course being played in the 2007 US Open major golf tournament. Should the user select (clicking, tapping, by voice commend, etc.) the multi-grid view button 1153, this initiates a triggering of advanced processing in the system to analyze the metadata of the current round shown in grid 1000A (here, shows as holes 1 to 3 in Round 1) and to automatically generate up to “n” additional grids (here only two grids 1000A1 and 1000A2 are shown for brevity) these two grids showing video content of the same holes 1 to 3 in follow-on rounds 2 and 3 of the tournament, each grid containing an entire set of new containers 1030 with different but related video content.

Thus, upon a setting or parameter selection by the user in this example, the system expands the initial grid 1000 view by creating new column×row grids 1000A1 and 1000A2, each new grid having containers 1030 which organizes video clips (nodes 1040) similarly, e.g., displaying specific holes, specific featured players, and/or key moments in a given round, ensuring visual consistency and easy visual cross-comparison for the user. FIG. 13 may also highlight metadata-driven organization in that the formation and display of these grids 1000A1, 1000A2 . . . 1000A(n) provides searchable metadata (e.g., round identifiers, player performance indicators, hole numbers) so that each grid is highly relevant to its round. This permits a straightforward mechanism by which the user can consider multiple aspects of the tournament at a single glance of the display

The design of a multi-grid view offers several unique navigation paths for users for this golf tourney example, including but not limited to an ability to navigate across rounds, intra-grid navigation, cross-round correlation, and/or multipath discovery. In navigating across rounds, users may make direct transitions to switch seamlessly between round grids (Rounds 1, 2, and 3) using directional keys on a TV remote, swipe gestures on touch-enabled devices, or voice commands such as “Go to Round 2” or “Show Round 3 highlights”, for example. Additionally, the grids 1000A1, 1000A2 . . . 1000A(n) may be presented in a vertical stack, so scrolling up or down cycles through rounds to enable comparisons across similar holes across rounds, without leaving the overall tournament context. Intra-grid navigation may be facilitated as well. In an example, and within each grid, arrow keys may be displayed or accessed to allow users to traverse each container and/or node. For example, the user may move horizontally to switch between holes or vertically to jump from one featured video content type to another (e.g., from drive highlights to putting sequences). Also, selecting a particular container 1030 not only plays the corresponding video content (nodes 1040) but can also trigger additional contextual options (e.g., “View more from this hole” or “See player comparisons across rounds”), creating branching navigation pathways.

In some implementations cross-round correlations may offer contextual thumbnails and dynamic reconfiguration aspects to the user experience. As an example of contextual thumbnails, some grid containers 1030 (or nodes 1040 within containers 1030) could be configured as gateway nodes that showcase comparative thumbnails. For example, from Round 1's side by side view of Tiger Woods and Phil Mickelson, a user might tap a “compare across rounds” icon. This automatically may cause the display of a side-by-side comparison grid where corresponding holes from Rounds 2 and 3 are arranged next to each other. For dynamic reconfiguration, system processing in the system may be configured to reconfigure grids on the fly so that, for instance, if a user is focusing on a particular hole in Round 1, the interface highlights the same hole (or set of holes) in Rounds 2 and 3.

The multi-grid view may further offer multipath discovery, such as through sequential navigation, parallel comparison, and thematic exploration operation. For example, in on example, the user may opt to consume the content sequentially round by round, from round 1 to round 2 and then round 3, to follow the progression of gameplay and strategy shifts. Alternatively, in one example the user might jump from a specific highlight in round 1 to the same moment captured in other rounds, providing immediate parallel comparative insights. Further, as an example of thematic exploration, in an example users with a keen interest in a specific feature (such as a player's performance on a particular hole) can have related content automatically fetched and organized within a sub-grid that spans all three rounds.

An example navigation scenario in light of the above description for this golf tournament might play out as follows. In this scenario, assume the user starts by exploring Round 1 clips of Tiger Woods at the 2007 Open (where previous selection of a node 1040 or container 1030 selecting Tiger Woods) may present an initial grid such as 1000 in FIG. 12 with the various setting and parameter options. The user selects button 1150 in FIG. 12 to result in grid 1000A of FIG. 13 to explore round 1 clips of Tiger Woods at the 2007 Open, and then from grid 1000A selects the multi-grid view button 1153, After selecting the multi grid button 1153, grids 1000A1 and 1000A2 (and subsequent grids, if desired), round 1 in the grid 1000A is displayed as the initial state in this example, such as key moments by hole (e.g., Hole 1, Hole 2, Hole 3). The user may quickly review or scan the content with a TV remote or by swiping on a touch interface.

To transition to the multiple displayed grids 1000A1 and 1000A2 for example, the user selects the multi-grid view button 1153 on grid 1000A. This action triggers (automatically generates) new grids 1000A1, 1000A2 (and up to 1000A(n) as set or programmed) and new containers 1030 for rounds 2 and 3. The user employ directional arrows (or voice commands like “Next Round”) to navigate vertically from the Round 1 grid to Round 2 and then Round 3. Here, the user may desire to explore desired paths within rounds, such as selecting a container 1030 containing a particular hole. In an example, container selection might generate a pop-up or expanded view to offer additional navigation options, such as comparing that hole across rounds or accessing detailed highlight reels.

In one example, system processing may be configured to present the user an ability to opt into a “compare all performances” selection on Hole 1 across the three rounds. This may trigger another user interface reconfiguration, presenting a dedicated comparison grid that juxtaposes the hole-specific clips in side by side or in vertical fashion for example.

Accordingly, by selecting the multi-grid view button 1155, an expansive ecosystem of interlinked content options may be opened to the user. The automatic generation of additional grids and associated new containers for rounds 2 and 3 (in this example) allows users to exploit multiple navigation paths, whether sequentially, parallelly, or thematically, across a three-layer grid system in this working example. This fluid and dynamic environment not only may enrich the viewing experience, but also may provide hardcore golf fans with a powerful tool to explore every nuance of the tournament footage, thereby transforming passive watching into an immersive discovery journey.

One or more aspects of the embodiments may be implemented as processing blocks in a software program, including possible implementation as a digital signal processor, microcontroller, or general-purpose computer; however, described embodiments are not so limited. As would be apparent to one skilled in the art, various functions of software might also be implemented as processes of circuits. Such circuits might be employed in, for example, a single integrated circuit, a multi-chip module, a single card, or a multi-card circuit pack.

Described embodiments might also be embodied in the form of methods and apparatuses for practicing those methods. Described embodiments might also be embodied in the form of program code embodied in non-transitory tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing described embodiments. Described embodiments might also be embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the described embodiments. When implemented on a general-purpose processor, the program code segments combine with the processor to provide a unique device that operates analogously to specific logic circuits. Described embodiments might also be embodied in the form of a bitstream or other sequence of signal values electrically, optically, or wirelessly transmitted through a medium, stored magnetic-field variations in a magnetic recording medium, etc., generated using a method and/or an apparatus of the described embodiments.

It should be understood that the steps of the methods set forth herein are not necessarily required to be performed in the order described, and the order of the steps of such methods should be understood to be presented as examples. Likewise, additional steps might be included in such methods, and certain steps might be omitted or combined, in methods consistent with various described embodiments.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard. Unless explicitly stated otherwise, each numerical value and range should be interpreted as being approximate as if the word “about” or “approximately” preceded the value of the value or range.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports might be referred to by the same name and are interchangeable for purposes here.

As used herein, expressions such as “include” and “may include” which may be used in the present disclosure denote the presence of the disclosed functions, operations, and constituent elements, and do not limit the presence of one or more additional functions, operations, and constituent elements. In the present disclosure, terms such as “include” and/or “have”, may be construed to denote a certain characteristic, number, operation, constituent element, component or a combination thereof, but should not be construed to exclude the existence of or a possibility of the addition of one or more other characteristics, numbers, operations, constituent elements, components or combinations thereof.

As used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As used herein, to “provide” an item means to have possession of and/or control over the item. This may include, for example, forming (or assembling) some or all of the item from its constituent materials and/or, obtaining possession of and/or control over an already-formed item.

Unless otherwise defined, all terms including technical and/or scientific terms used herein have the same meaning as commonly understood by one of ordinary skill in the art to which the present disclosure pertains. In addition, unless otherwise defined, all terms defined in generally used dictionaries may not be overly interpreted. In the following, details are set forth to provide a more thorough explanation of the embodiments. However, it will be apparent to those skilled in the art that embodiments may be practiced without these specific details. In other instances, well-known structures and devices are shown in block diagram form or in a schematic view rather than in detail in order to avoid obscuring the embodiments. In addition, features of the different embodiments described hereinafter may be combined with each other, unless specifically noted otherwise. For example, variations or modifications described with respect to one of the embodiments may also be applicable to other embodiments unless noted to the contrary.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A sensor refers to a component which converts a physical quantity to be measured to an electric signal, for example, a current signal or a voltage signal. The physical quantity may for example comprise electromagnetic radiation (e.g., photons of infrared or visible light), a magnetic field, an electric field, a pressure, a force, a temperature, a current, or a voltage, but is not limited thereto.

Use of the phrases “capable of,” “capable to,” “operable to,” or “configured to” in one or more embodiments, refers to some apparatus, logic, hardware, and/or element designed in such a way to enable the use of the apparatus, logic, hardware, and/or element in a specified manner. Use of the phrase “exceed” in one or more embodiments, indicates that a measured value could be higher than a pre-determined threshold (e.g., an upper threshold), or lower than a pre-determined threshold (e.g., a lower threshold). When a pre-determined threshold range (defined by an upper threshold and a lower threshold) is used, the use of the phrase “exceed” in one or more embodiments could also indicate a measured value is outside the pre-determined threshold range (e.g., higher than the upper threshold or lower than the lower threshold). The subject matter of the present disclosure is provided as examples of apparatus, systems, methods, circuits, and programs for performing the features described in the present disclosure. However, further features or variations are contemplated in addition to the features described above. It is contemplated that the implementation of the components and functions of the present disclosure can be done with any newly arising technology that may replace any of the above-implemented technologies.

The detailed description is made with reference to the accompanying drawings and is provided to assist in a comprehensive understanding of various example embodiments of the present disclosure. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments. In addition, descriptions of well-known functions and constructions may be omitted for clarity and conciseness. Accordingly, those of ordinary skill in the art will recognize that various changes and modifications of the examples described herein can be made without departing from the spirit and scope of the present disclosure.

Various modifications to the disclosure will therefore be readily apparent to those skilled in the art, and the generic principles defined herein may be applied to other variations without departing from the spirit or scope of the present disclosure. Throughout the present disclosure the terms “example,” “examples,” or “exemplary” indicate examples or instances and do not imply or require any preference for the noted examples. Thus, the present disclosure is not to be limited to the examples and designs described herein but is to be accorded the widest scope consistent with the principles and novel features disclosed.

What is claimed:

1. A method executed by one or more computing devices for enhanced navigation of a three-dimensional interactive grid for a multi-dimensional search of video content therein, comprising:
displaying, via a user interface, at least one three-dimensional interactive grid composed of a plurality of cells populated with the video content or otherwise adapted to receive the video content therein, the plurality of cells further including:
a plurality of differently named chapters of the video content,
a plurality of differently named subchapters associated with each chapter, the plurality of chapters and subchapters forming headers of the plurality of cells in a multiple column by multiple row arrangement as two dimensions of the three dimensional interactive navigation grid,
a plurality of containers of video content associated with each subchapter and representing a third dimension, each container containing one or more nodes of video snippets associated therewith, and
enabling a multi-dimensional search via the user interface of video content associated with selection of a given node in a given container or selection of a given container, the selection initiating a hierarchical search to display at least one or more new containers related to the selected given node or given container, the new containers accessible in the presently displayed three dimensional interactive grid or accessible in one or more different three dimensional interactive grids related to the video content of the selected node,
the displaying and enabling steps being performed by computer software adapted to run on computer hardware.

2. The method of claim 1, wherein the video content includes pre-rendered, non-live program video content.

3. The method of claim 2, wherein the pre-rendered, non-live program video content is configured so as to be processed in real time.

4. The method of claim 2, wherein a given three dimensional grid is configured to dynamically re-populate the pre-rendered, non-live program video content.

5. The method of claim 4, wherein dynamic re-population is triggered by at least one of one or more user-initiated events, system automation, or a trained model.

6. The method of claim 1, wherein the enabled multi-dimensional search is operable across all three dimensions of the presently displayed three dimensional interactive grid and actionable across any different three dimensional interactive grids linked to the selected node.

7. The method of claim 1, wherein
the hierarchical search of video content further comprises a structured drill-down search performed in real time based on said metadata associated with the selected node or container,
the metadata includes at least one of hashtags, timestamps, and geolocation data, and
the search retrieves all nodes in one or more given containers that are within one or more three-dimensional interactive grids linked to the video content associated with the selected node or container.

8. The method of claim 7, further comprising a step of automatically displaying a nested sub-container when a given node is selected, where the sub-container contains additional nodes that represent a lower layer of detail in the video content hierarchy.

9. The method of claim 7, wherein the structured drill-down search is driven by contextual filtering that utilizes metadata associated with the selected node to dynamically refine and narrow subsequent search results, the search being performed in real time based on said metadata, which includes at least one of hashtags, timestamps, and geolocation data.

10. The method of claim 9, further comprising a step of categorizing video content into a predefined taxonomy such that selection of the given node or given container automatically restricts the structured drill-down search to display nodes within the same category.

11. The method of claim 7, wherein the structured drill-down search includes a dynamic filtering mechanism configured to adjust displayed nodes in real time based on real-time user preferences or system-detected engagement metrics, and further configured to sort nodes by attributes including at least one of relevance, chronology, and popularity.

12. The method of claim 7, wherein the structured drill-down search incorporates one or both of spatial filtering and temporal filtering to allow for the selection of video content nodes that are optimized based on time of capture or geographical context associated with the video content.

13. The method of claim 7, further including a step of reordering subsequent containers and nodes based on historical user behavior and interaction patterns, such that the drill-down search continuously optimizes for user-specific content engagement.

14. The method of claim 1, wherein
any container is configured to be populated with nodes and associated video content in real time from any source,
any source includes one or more of public sources of video content, private sources of video content, and grid manipulations via the user interface, and
grid manipulations via the user interface include one or more of structural changes, source node replacements, and container-level adjustments.

15. A three-dimensional interactive grid for a multi-dimensional search of video content therein that is displayable via a user interface, comprising:
a plurality of cells including:
a plurality of differently named chapters of the video content, the video content represented as pre-rendered, non-live program video content,
a plurality of differently named subchapters associated with each chapter, the plurality of chapters and subchapters forming two dimensions of the three dimensional interactive navigation grid, and
a plurality of containers associated with each subchapter and representing a third dimension, each container containing one or more nodes of video snippets of the pre-rendered, non-live program video content associated therewith, wherein the pre-rendered, non-live program video content is configured to be processed in real time.

16. The three-dimensional interactive grid of claim 15, wherein
the grid is configurable to dynamically re-populate the pre-rendered, non-live program video content in nodes of the containers, and
any container is configured to be populated with nodes and associated video snippets of pre-rendered, non-live program video content in real time from any source.

17. A computer system adapted for enhanced navigation of a three-dimensional interactive grid for a multi-dimensional search of video content therein, the system comprising:
a processing hardware set, and
a computer-readable storage device medium, wherein the processing hardware set is structured, connected and/or programmed to run program instructions stored on the computer-readable storage medium instructions and associated data, the program instructions including:
a display module programmed via a user interface to display at least one three-dimensional interactive grid composed of a plurality of cells populated with the video content or otherwise adapted to receive the video content therein, the plurality of cells further including:
a plurality of differently named chapters of the video content,
a plurality of differently named subchapters associated with each chapter, the plurality of chapters and subchapters forming headers of the plurality of cells in a multiple column by multiple row arrangement as two dimensions of the three dimensional interactive navigation grid,
a plurality of containers of video content associated with each subchapter and representing a third dimension, each container containing one or more nodes of video snippets associated therewith; and
a processing module programmed to:
enable a multi-dimensional search via the user interface of video content associated with selection of a given node in a given container, or selection of a given container, and
automatically initiate a hierarchical search to display at least one or more new containers related to the selected given node or given container, the new containers accessible in the presently displayed three dimensional interactive grid or accessible in one or more different three dimensional interactive grids related to the video content of the selected node.

18. The system of claim 17, wherein
the video content includes pre-rendered, non-live program video content configured to be processed in real time,
a given three dimensional grid is configured so as to dynamically re-populate the pre-rendered, non-live program video content, and
dynamic re-population is triggered by at least one of one or more user-initiated events, system automation, or a trained model.

19. The system of claim 17, wherein
the hierarchical search is implemented as a structured drill-down search performed in real time based on said metadata associated with the selected given node or selected given container, and
the structured drill-down search retrieves all nodes in one or more given containers that are contained within one or more three-dimensional interactive grids linked to the video content of the selected node or container.

20. The system of claim 17, wherein any container is configured to be populated with nodes and associated video content in real time from any source.
